(19) United States
(12) Patent Application Publication
(10) Pub. No.: US 2024/0228278 A1
(43) Pub. Date: Jul. 11, 2024

(54) Method for preparation of supervalent metal hydrides

(71) Applicant: National Technology & Engineering Solutions of Sandia, LLC, Albuquerque, NM (US)

(72) Inventors: Peter Anand Sharma, Albuquerque, NM (US); Vitalie Stavila, Oakland, CA (US); Sakun Duwal, Albuquerque, NM (US); Dan Catalin Spataru, Danville, CA (US)

(21) Appl. No.: 18/403,863

(22) Filed: Jan. 4, 2024

Related U.S. Application Data
(60) Provisional application No. 63/437,494, filed on Jan. 6, 2023.

(51) Int. Cl. C01B 6/00

(52) U.S. Cl. CPC C01B 6/003; C01P 2002/77

(57) ABSTRACT

Rare earth (RE) superhydrides exhibit high temperature superconductivity but are difficult to characterize and use in applications due to their high formation and stability pressures, which are typically in excess of 100 GPa. Cryomilling of metal precursors improves hydrogen reactivity and hydrogen uptake for forming such metal hydrides at lower pressures. As an example, an elemental lanthanum precursor was milled at liquid nitrogen temperatures for different time intervals. After exposure to gaseous hydrogen at 380° C. and 100 bar, a systematic enhancement of hydrogen absorption with increasing ball milling time was found for forming the LaHₓ, x=2-3 phase. Exposing the La precursor to pressures up to 60 GPa with an ammonia borane (BNH₆) hydrogen source resulted in a hypervalent LaH₄ phase. This LaH₄ phase is associated with the suppression of a rhombohedral distortion of the Fm3̅m cubic structure after cryomilling the precursor.

### CROSS-REFERENCE TO RELATED APPLICATIONS

This application claims the benefit of U.S. Provisional Application No. 63/437,494, filed Jan. 6, 2023, which is incorporated herein by reference.

### FEDERALLY SPONSORED RESEARCH AND DEVELOPMENT

This invention was made with Government support under Contract No. DE-NA0003525 awarded by the United States Department of Energy/National Nuclear Security Administration. The Government has certain rights in the invention.

### BACKGROUND OF THE INVENTION

Hypervalent metal hydrides, composed of rare earth or alkali metal species and large hydrogen-metal ratios, have been shown by experiments and ab initio calculations to support superconductivity at maximum transition temperatures of over 200° K. See M. Somayazulu et al., Phys. Rev. Lett. 122(2), 027001 (2019); A. P. Drozdov et al., Nature 569(7757), 528 (2019); L. Ma et al., Phys. Rev. Lett. 128(16), 167001 (2022); P. Kong et al., Nat. Commun. 12(1), 5075 (2021); E. Snider et al., Phys. Rev. Lett. 126(11), 117003 (2021); Z. Li et al., Nat. Commun. 13(1), 2863 (2022); Y. Wang et al., Chin. Phys. B 31(10), 106201 (2022); H. Liu et al., Proc. Natl. Acad. Sci. 114(27), 6990 (2017); H. Wang et al., Proc. Natl. Acad. Sci. 109(17), 6463 (2012); F. Peng et al., Phys. Rev. Lett. 119(10), 107001 (2017); Y. Li et al., Sci. Rep. 5(1), 9948 (2015). However, these materials are only stable at pressures in excess of 100 GPa, which greatly limits the available characterization techniques one can use to study this phenomenon. Applications are also not possible at these very high pressures. One would like to find a metal hydride that supports high temperature superconductivity that can be both synthesized and remain stable at far lower pressures, ideally at ambient pressure.

All of the rare earth (RE) elements normally form hydrides at low pressures with a stoichiometry of REHₓ with x up to ˜3 with variable hydrogen/metal fraction limited by the number of available interstitials in the rare earth host lattice. See P. Vajda, “Hydrogen in rare-earth metals, including RH2+x phases,” in Handbook on the Physics and Chemistry of Rare Earths, Elsevier, p. 207-291 (1995). Solid hydrogen, which occurs at pressures greater than 600 GPa, has long been postulated to be a high temperature superconductor due to its light mass and potential for strong electron-phonon coupling. See M. Eremets and A. Drozdov, “Comments on the claimed observation of the Wigner-Huntington transition to metallic hydrogen,” arXiv preprint arXiv: 1702.05125 (2017); and N. W. Ashcroft, Phys. Rev. Lett. 92(18), 1748 (1968). The central idea behind realizing high temperature superconductivity in metal hydrides is to synthesize a material with a covalently bonded hydrogen network supported by the metal sublattice. See N. W. Ashcroft, Phys. Rev. Lett. 92(18), 187002 (2004). For instance, the hydrogen sublattices in these materials often take on exotic structural motifs such as cages. See E. Zurek and T. Bi, J. Chem. Phys. 150, 050901 (2019). Thus, large amounts of hydrogen are needed in the “supervalent” metal hydrides and the metal sublattice must expand in volume to accommodate larger hydrogen/metal fractions to potentially realize novel hydrogen bonding sites. These supervalent rare earth hydrides require large pressures due to the combination of kinetic barriers to insert hydrogen and the thermodynamic stability of the crystal structures.

In order to address the problem of achieving supervalent hydrides at lower pressures, prior research has focused on computing the transition temperature and formation pressure for a wide variety of different binary and ternary hydrides using ab initio methods to inform further experimentation of equilibrium compounds. See J. A. Flores-Livas et al., Phys. Rep. 856, 1 (2020); D. V. Semenok et al., Curr. Opin. Solid State Mater. Sci. 24(2), 100808 (2020); and S. Di Cataldo et al., Phys. Rev. B 104(2), L020511 (2021). Doping of an existing hydride is also being explored on both the rare earth and hydrogen sites for this purpose. See J. Bi et al., Nat. Commun. 13(1), 5952 (2022); Z. Wu et al., Phys. Rev. Mater. 7(10), L101801 (2023); W. Chen et al., Nat. Commun. 14(1), 2660 (2023); and Y. Song et al., Phys. Rev. Lett. 130(26), 266001 (2023). Both of these prior approaches have shown how phase stability of supervalent superconducting hydrides can be achieved at lower pressures.

### SUMMARY OF THE INVENTION

The present invention is directed to a method for preparation of a supervalent metal hydride, comprising providing a metal powder; cryomilling the metal powder for a milling time to provide a cryomilled metal precursor; and applying a pressure to the cryomilled metal powder in the presence of a source of hydrogen, sufficient to form a supervalent metal hydride. For example, the milling time can be greater than 60 minutes. For example, the pressure applied can be from about 100 MPa to 100 GPa. The method can further comprise exposing the cryomilled metal precursor to an elevated temperature in the presence of the source of hydrogen.

As an example of the invention, cryomilling a lanthanum (La) powder was shown to alter the hydrogen absorption properties and formation of supervalent hydrides at high pressures. Cryomilling systematically enhanced the hydrogen absorption kinetics and hydrogen/metal fraction at 380° C.and 100 bar of H₂ gas. Cryomilling-induced metastability was also observed in the high pressure phase transformations of LaHx powder. The formation of a supervalent hydride, LaH₄, with a rhombohedral phase was observed at >30 GPa under hydrogen exposure using ammonia borane through the application of cryogenic mechanical ball milling of La powder at a maximum milling time of 120 minutes. Density functional theory (DFT) calculations were used to propose optimized hydrogen positions and support identification of the supervalent phase through equation-of-state modeling. Therefore, cryomilling of a metal precursor can be a useful route to lower the formation pressure and promote metastability at lower pressures in supervalent hydrides.

### BRIEF DESCRIPTION OF THE DRAWINGS

The detailed description will refer to the following drawings, wherein like elements are referred to by like numbers.

FIG. 1 is a schematic flow diagram of a method of the invention.

FIG. 2 shows Dynamic Light Scattering (DLS) measurements of La particles dispersed in 200 proof ethanol for as-received (325 mesh) and cryomilled (120 and 300 minutes) powders. The relative size distribution of cryomilled powder changes systematically with cryomilling time. The lower panel shows the cumulative distribution, highlighting the hydrodynamic diameter where 50% of the particles are under the size indicated by the dashed lines for each category of sample.

FIG. 3 is a graph of isothermal hydrogen absorption as a function of time at a fixed H₂ pressure of 100 bar and T=380° C.for La powder cryomilled at different lengths of time. Compared to the as-received La powder, cryomilled precursor materials systematically absorb hydrogen at a faster rate and absorb a larger total amount of hydrogen (inset).

FIG. 4A shows the lattice parameters and FIG. 4B shows the c/a ratios for cryomilled La mixed with ammonia borane at room temperature for various milling times and applied pressures. The hydride formed from this La material in the presence of H₆BN undergoes a distortion from Fm3̅m to R3̅m. Cryomilling the La precursor changes the pressure where this phase transformation occurs. The a and c parameters are defined in the hexagonal setting of the R3̅m phase. The c/a ratio is highest for the cryomilled samples compared to the as-received powder. The c/a ratio in the ideal Fm3̅m structure is 2.45 by definition.

FIG. 5 shows equation-of-state (P-V) measurements for cryomilled La mixed with ammonia borane at room temperature as a function of pressure. The unit cell volume was extracted from X-ray diffraction data for cryomilled samples (open red and blue squares) and compared with as-received La (open black squares) when mixed with ammonia borane. The as-received La was measured without ammonia borane (closed squares) and agrees with the prevailing literature. The equation-of-state was calculated using DFT for the known and proposed structures for LaH₂, LaH₃, and LaH₄ (black, blue, and red lines, respectively) and compared with the data.

FIG. 6 shows a ball and stick model of the LaH₄ structure. Two different views are shown.

FIG. 7 is a graph of ground state enthalpy difference per formula unit relative to the Fm3̅m LaH₂ structure over the entire pressure range studied. Decomposition of the lower hydride LaH₂ into LaH and LaH₃ is energetically favorable over decomposition into LaH and LaH₄, where the LaH₄ phase has a R3̅m structure. Calculations for the other phases assume Fm3̅m.

### DETAILED DESCRIPTION OF THE INVENTION

The present invention is directed to the preparation of non-equilibrium supervalent metal hydrides by modifying the precursor material using mechanical milling followed by exposure to hydrogen. Mechanical ball milling is a process whereby a starting precursor is subjected to high energy impacts in order to accomplish either comminution (reducing particles sizes) or attrition (plastic deformation and damage to a particle of a given size). See C. L. DeCastro and B. S. Mitchell, “Nanoparticles from mechanical attrition,” in Synthesis, functionalization, and surface treatment of nanoparticles, (2002). A powder charge is added into a sealed metal chamber with spherical milling balls, which then undergoes vibrations (e.g., 10-1000 Hz) in order to generate collisions of the metal powder with the milling media. Cryogenic temperatures are used to avoid local heating and recrystallization and/or to make the milled material more brittle in soft materials, such as soft metals, enabling fracture. See D. B. Witkin and E. J. Lavernia, Prog. Mater. Sci. 51(1), 1 (2006).

Milling is one of many processing methods used to achieve phase transformations that are far out of equilibrium under prevailing conditions. See D. Turnbull, Metall. Mater. Trans. B 12, 217 (1981); and C. Suryanarayana, J. Mater. Sci. 53(19), 13364 (2018). High pressure phases of binary rare earth alloys and elemental lanthanum have been stabilized under ambient conditions using mechanical milling. See S. K. Han et al., Scr. Metall. 25(1), 295 (1991); and T. Alonso et al., Scr. Metall. Mater. 25(7), 1607 (1991). Milling techniques are also commonly used to form non-equilibrium phases that enable higher hydrogen loading in metal hydrides for hydrogen storage. See O. Faye et al., Int. J. Hydrog. Energy 47(29), 13771 (2022); and J. Huot et al., Materials 12(17), 2778 (2019). The reasoning behind mechanical milling is motivated by the large pressures and temperatures experienced between two colliding spherical particles with a small contact area, which can be viewed as an alternative way of exposing a material to a (transient) high pressure environment followed by a rapid quench. See M. Magini et al., Scr. Mater. 34(1), 13 (1996).

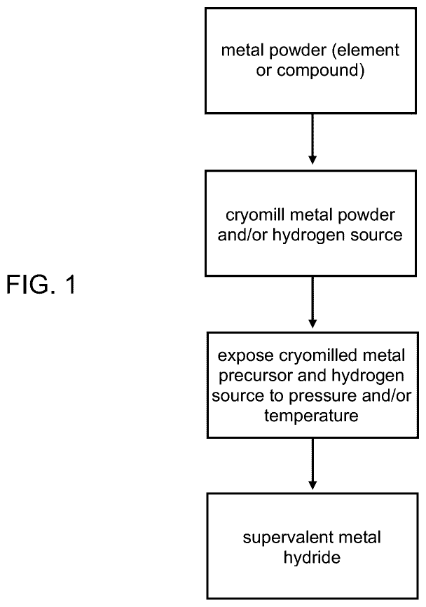

FIG. 1 describes a general manner in which the method of the present invention is accomplished. A metal powder (element or compound) is prepared for cryomilling. For example, the metal powder can comprise a rare-earth element, such as scandium, lanthanum, yttrium, or ytterbium; an alkaline earth element, such as magnesium or calcium; a transition metal, such as zirconium or hafnium; or alloys or compounds thereof. Preparation can include washing the metal powder in alcohol or similar non-hydrous liquid to remove contamination and debris before subjecting the powder to cryomilling. The metal powder is then cryomilled either alone or in combination with a gaseous, liquid, or solid hydrogen source. The cryomilling process occurs typically at liquid nitrogen temperatures with the powder and milling media either directly exposed to the liquid cryogen or in a milling container that is cooled to liquid nitrogen temperatures. For the experiments described below, a Retsch cryomill was used with an integrated cooling system which continually cools the grinding container with liquid nitrogen to keep the milling temperature at −196° C. A zirconia milling medium and a milling power of 25 Hz provided a relatively high grinding efficiency, resulting in a defected cryomilled metal with small grain size (microns). The duration of the cryomilling is variable. A typical milling time is 30 minutes to several hours, but can last as long as is needed for a particular process. Milling can be done in a gaseous environment, such as forming gas or hydrogen gas, to promote partial hydrogenation of the cryomilled metal. The milling process can also be performed in the presence of a solid-phase hydrogen source, such as ammonia borane (NH₃BH₃). Any liquid or solid hydrogen-containing compound that dehydrogenates to generate a local source of hydrogen gas can be used, including borohydrides, boranes, paraffin-based oils, or liquid hydrocarbons. The metal powder will spontaneously react to form a hydride in the presence of hydrogen gas. In order to promote a supervalent ratio of hydrogen-to-metal, exposure to a hydrogen source under pressure with or without heating can then be performed on the cryomilled metal in a pressure apparatus. For example, the cryomilled metal precursor in combination with a hydrogen source can be exposed to high temperatures followed by high pressures, or high pressures and then high temperatures, or high pressure and high temperature simultaneously. High pressure can be applied via a diamond anvil cell (DAC) or piston, for example. At pressures <100 MPa, metal tanks can be constructed to withstand and support a high pressure environment in which metal-hydride reaction can occur. In the examples described below, pressure was applied in a DAC at room temperature. However, lower pressures and/or higher temperatures can also be used. Heating can be achieved by illuminating the sample chamber of the DAC with a focused light source or by direct resistive heating of the sample or by placing the sample in a furnace. The resulting product is a hydrogen-rich metal hydride that may exhibit superconductivity.

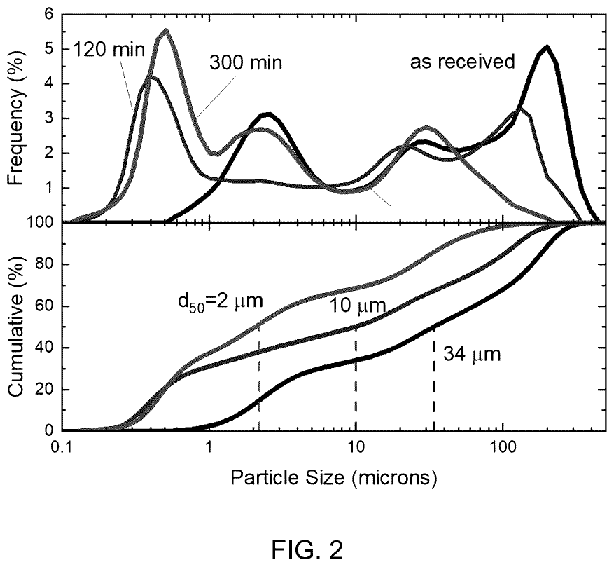

As an example of the invention, cryogenic ball milling of elemental lanthanum was performed over different durations and then this modified precursor was exposed to hydrogen. As shown in FIG. 2, dynamic light scattering (DLS) of the cryomilled powder showed a systematic decrease in median particle size of 34 μm, 10 μm, and 2 μm for the as-received, 120 minutes cryomilled, and 300 minutes cryomilled powder, respectively. The cryomilled precursor powders generally had minimum particle sizes of ˜500 nm. Scanning electron microscopy (SEM) also indicated some reduction and homogenization of particle size, but comminution and attrition likely both occur.

After forming a cryomilled lanthanum precursor, the formation of any higher hydrides was studied at pressures up to 60 GPa with synchrotron X-ray diffraction using a DAC. Ammonia borane (BNH₆) was used as an internal hydrogen source where indicated, which irreversibly decomposes to BN and H₂ gas. While full decomposition is known to occur at 500° C., at ambient conditions there is sufficient hydrogen gas evolved to form hydrides readily within days. See J. Nylén et al., J. Chem. Phys. 131(10), 104506 (2009). Ammonia borane/metal ratios were prepared in a 10:1 ratio by mass. LaH₂₊ₓ formed readily when mixed with this compound under ambient pressure and temperature conditions. As described below, a hydrogen deficient LaH₄ phase with an expanded unit cell was found following high pressure exposure to the hydrogen source. Cryogenically ball milled precursors increased the pressure at which this distorted unit cell was observed but increased the hydrogen content in the supervalent metal hydride. Therefore, suitable modification of the metal precursor can change the thermodynamic stability for a supervalent hydride.

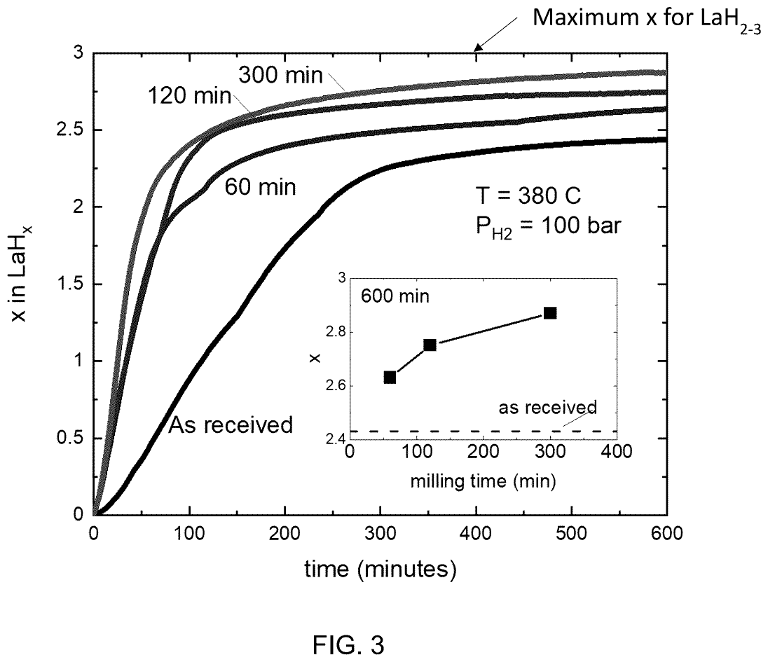

The primary control variable was the amount of time spent milling the starting lanthanum powder at liquid nitrogen temperatures. Therefore, hydrogen absorption measurements were performed using the Sieverts technique at a temperature of 380° C. and a pressure of 100 bar in pure H₂ gas to determine the effects of cryomilling on hydrogen absorption. These absorption measurements were carried out for a maximum time of 600 minutes in a fixed volume under pure (99.99%) H₂ gas in order to ensure equilibrium and allow a direct characterization of the amount of hydrogen absorbed in a metal precursor. FIG. 3 shows that both the rate of hydrogen absorption and the total amount of hydrogen in the lanthanum precursor (inset) increase with increasing milling time. The as-received crystal structure of lanthanum was face centered cubic (fcc) and did not change for any cryomilling or post H₂ annealing condition as determined from ambient pressure X-ray diffraction measurements.

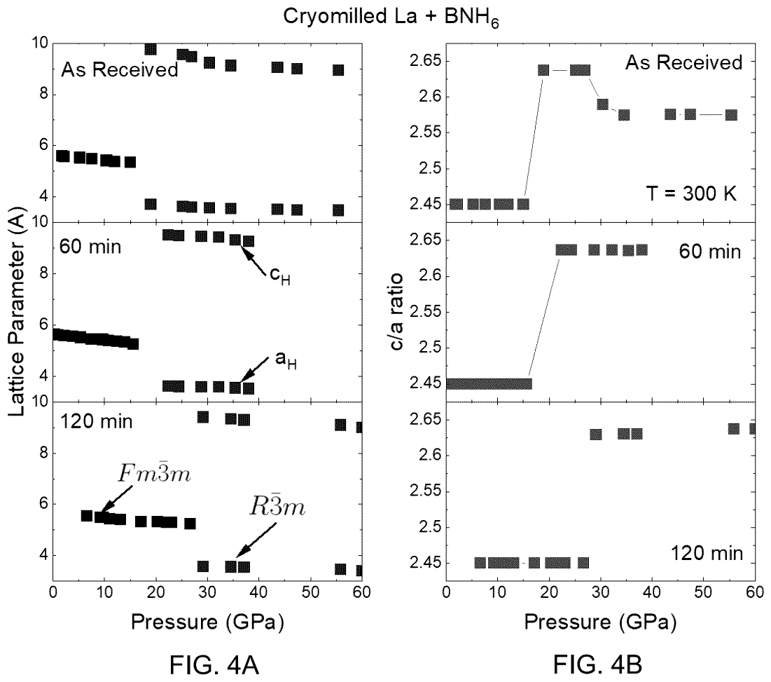

FIGS. 4A and 4B show the evolution of the crystal structure of lanthanum hydrides formed by exposure of the cryomilled La precursor to ammonia borane. Cryomilled lanthanum was exposed to pressure up to 60 GPa with solid ammonia borane powder as a source of hydrogen, mixed by mortar and pestle in a 1:10 ratio (La:BNH₆) in an inert environment. X-ray diffraction was recorded at room temperature as the pressure was increased incrementally and then again upon decompression. Exposure of all La precursors to ammonia borane initially resulted in the Fm3̅m LaHx phase, indicating rapid hydrogenation at room temperature. The lattice parameter of this starting LaHₓ phase was ˜5.648 Å, irrespective of cryomilling condition, indicating a starting hydrogen composition of LaH_{2.2}. See C. Holley Jr. et al., J. Phys. Chem. 59(12), 1226 (1955). All hydride samples were observed to phase separate into compounds with higher (x>2) and lower (x<2) hydrogen content. See A. Machida et al., Phys. Rev. B 83(5), 054103 (2011). For clarity, only the higher hydride compounds are shown in FIG. 4A.

Upon further compression, this Fm3̅m structure transformed to a R3̅m structure, as shown in FIG. 4A. The formation of the R3̅m structure was accompanied by the coexistence of a lower LaHₓ phase, x˜1. The a_{H} and c_{H} lattice parameters of the R3̅m structure in the hexagonal setting are plotted in FIG. 4A. The pressure at which this phase transformation occurred increased with longer precursor cryomilling times. The body-diagonal distortion of the cubic Fm3̅m structure in this R3̅m phase can be quantified through the c/a ratio, as shown in FIG. 4B. For a and c lattice parameters in the hexagonal setting, the ideal Fm3̅m structure has a c/a ratio of 2.45, by definition. The as-received La precursor, exposed to ammonia borane under pressure, first distorts to c/a ˜2.65 then decreases to ˜2.55. In contrast, the cryomilled samples maintain c/a ˜2.65 up to 60 GPa. The increase in the critical pressure at which the distorted fcc phase was observed indicates that cryomilling aided in stabilizing the undistorted fcc phase at higher pressures compared to the control sample.

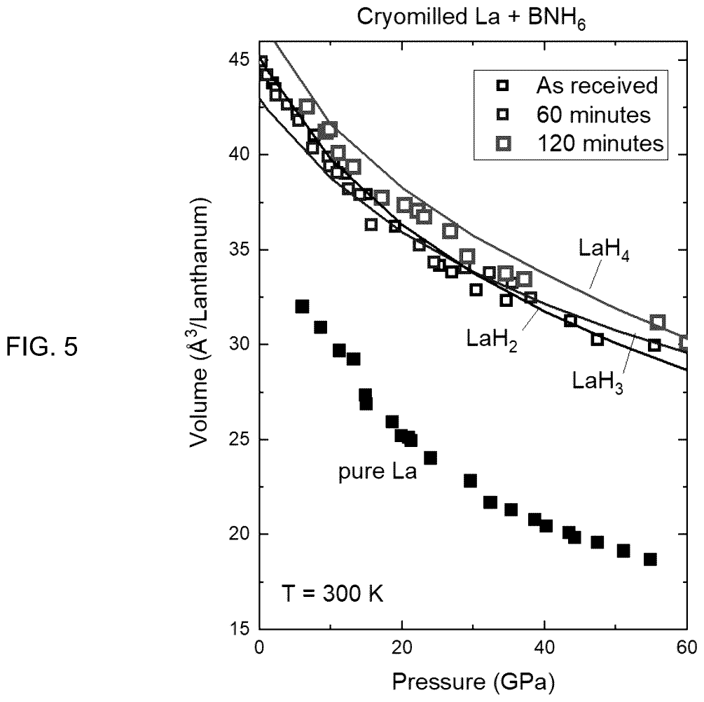

FIG. 5 compares the cell volume per formula unit as a function of pressure of the cryomilled material relative to the as-received La control sample. The cell volume of each material was extracted from FIGS. 4A and 4B and normalized by the number of atoms in the unit cell. Reference experiments performed on pure lanthanum (solid black squares) agree with the prevailing literature. See L. Chen et al., J. Phys. Condens. Matter 34(20), 204005 (2022); and K. Syassen and W. B. Holzapfel, Solid State Commun. 16(5), 533 (1975). The data for LaH_{2.2} up to 20 GPa agrees with prior literature on a hydride with very similar composition. See A. Machida et al., Phys. Rev. B 83(5), 054103 (2011). The cell volume per lanthanum increases with longer cryomilling times (blue and red open squares for 60 and 120 minutes, respectively) compared to the as-received control. The stoichiometry of this R3̅m phase at high pressure was inferred to be LaHₓ with x˜4 based on the excess cell volume compared to pure La.

To further understand the thermodynamic stability of this structure, given an inferred hydrogen content, ab initio calculations of different lanthanum hydride structures (LaHₓ with x=1, 2, 3 and 4) were performed with the observed structural evolution. In order to obtain the hydrogen positions, the structure was optimized within DFT at fixed pressures using the stoichiometry LaH₄. The fact that the hydrogen stoichiometry was variable was ignored, in particular that the hydrogen/metal ratio only reaches ˜4 at 60 GPa, since at room temperature hydrogen positions are likely statistically random over possible lattice sites and the symmetry of the La atoms does not change from x˜3-4 in the data. Zero-point effects of hydrogen were also discounted. From these optimized structures, the equation-of-state was computed for each of the phases participating in the reaction, which are overlayed with the experimental data in FIG. 5 over the entire pressure range. The equation-of-state of the 120 minute cryomilled sample more closely matches the R3̅m prediction for LaH₄. The XRD data thus point to an LaH₄ phase formed by cryomilling at high pressures based on the excess cell volume and DFT equation-of-state calculations. A R3̅m structure of LaHs was also found, but the equation-of-state and enthalpy for this phase were nearly identical to the Fm3̅m structure as the rhombohedral distortion was very small. Values of x>3 in LaHₓ are supervalent in the sense that the hydrogen content exceeds the maximum possible hydrogen/metal fraction for an fcc structure of the host La atoms in the LaH₃ phase. The as-received and 60 minute cryomilled samples also show a distorted R3̅m structure, so the enhanced hydrogen absorption in the 120 minute sample is not due to the structural change alone. The structural changes observed in FIGS. 4 and 5 were irreversible upon decompression.

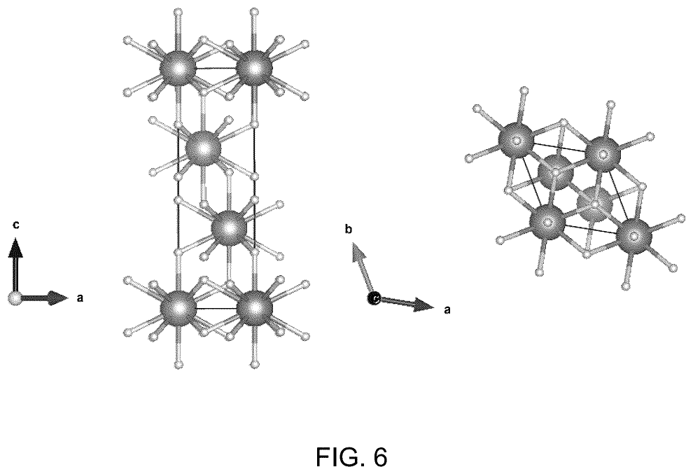

The structure of the proposed LaH₄ phase is shown in FIG. 6. The La and hydrogen positions shown here are distinct from previous XH₄ phases observed in the literature. The atomic coordinates for this structure are shown in Table 1. The lattice vectors are shown in Table 2.

TABLE 1
Atomic coordinates of the proposed LaH₄ phase

| Atom | X | Y | Z |
|---|---|---|---|
| La1 | 0 | 0 | 0 |
| H1 | 0.548 | 0.548 | 0.548 |
| H2 | 0.451 | 0.451 | 0.451 |
| H3 | 0.233 | 0.233 | 0.233 |
| H4 | 0.766 | 0.766 | 0.766 |

TABLE 2
Lattice vectors of the proposed LaH₄ phase

| Vector | X | Y | Z |
|---|---|---|---|
| A1 | 1.8 | 1.03 | 3.29 |
| A2 | −1.8 | 1.03 | 3.29 |
| A3 | 0 | −2.08 | 3.29 |

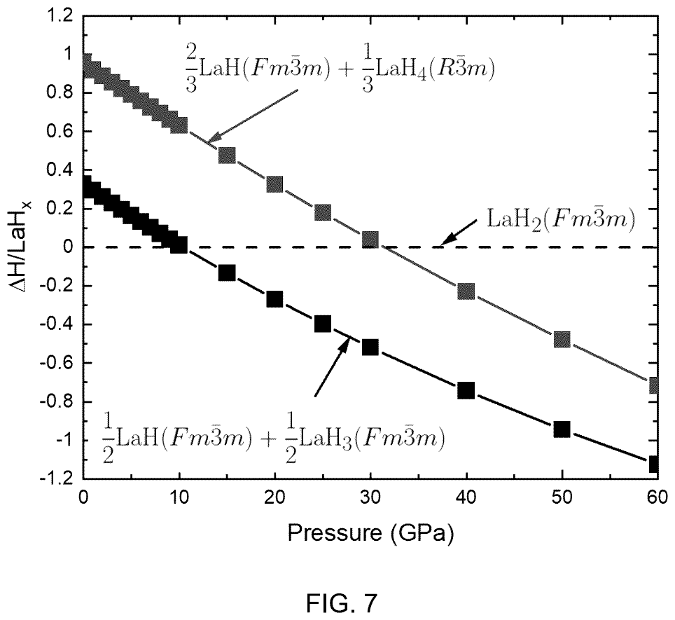

The stability of the observed LaH₄ phase relative to cubic LaH₃ was examined by computing the enthalpy of possible reactions amongst hydride phases as a function of pressure. The reaction LaH₂→αLaH+βLaHₓ was assumed and the volume fraction of the solid solution phase (α) and the higher hydride (β) was fixed in order to conserve hydrogen stoichiometry. The stoichiometry x was fixed at 3 and 4 to match the observed high pressure (˜60 GPa) value. The enthalpy of each possible reaction was then computed and is plotted as a difference of the products and LaH₂ in FIG. 7. This plot shows that the decomposition of LaH₂ to LaH₃ and LaH (lower curve) becomes exothermic at approximately 10 GPa. This result agrees with prior experimental and DFT studies, and thus benchmarks the calculations. See X. Ye et al., J. Phys. Chem. C 119(10), 5614 (2015). The calculations show that the LaH₄ phase becomes exothermic relative to LaH₂ at higher pressures of ˜30 GPa (upper curve). However, the normative LaH₃ phase was calculated to be stable over the entire pressure range studied (up to 60 GPa).

Thus, these DFT calculations show that the La sublattice structure with a hydrogen/metal ratio greater than 3 does not appear to be an equilibrium phase.

### DISCUSSION

The ball milling process increased the kinetics and thermodynamic stability for larger hydrogen loading of the lower lanthanum hydride phase as shown in FIG. 3. The kinetics of hydrogen reaction with a metal involves several steps. Di-hydrogen gas must first be transported to the surfaces, followed by dissociation into atomic hydrogen (possibly at special sites on the surface). This atomic hydrogen must then penetrate any surface barriers, such as oxides, and diffuse into the metal to form a surface hydride layer. Further diffusion must then occur through any metal hydride surface layers. On oxidized surfaces, H₂ dissociation and subsequent permeation through the oxide greatly limits the kinetics. See H. Uchida et al., J. Less-Common Met. 172-174, 832 (1991). Once through the oxide layer, hydrogen usually diffuses rapidly through the metal. The diffusivity of hydrogen in LaHₓ for x˜2.5 is approximately 1×10⁻¹⁰ m²/s at 380° C., corresponding to diffusion over 100 microns in 1 ms, and approximately an order of magnitude greater along grain boundaries. See G. Majer et al., Phys. Rev. Lett. 83(2), 340 (1999); and S .- I. Orimo and F. K. A. Günter Majer, Phys. Rev. B 63(9), 094307 (2001).

The data in FIG. 3 suggest that the starting powder is surface limited. The ball milling process increased the absorption rate of hydrogen with increased milling time, which could be due to an increased surface area and/or activation site density for hydrogen dissociation. In addition to an increase in hydrogen absorption rate, the amount of hydrogen absorbed at saturation also increased with increasing milling time. The low pressure La-H system has three main phases. See P. Vajda, “Hydrogen in rare-earth metals, including RH₂₊ₓ phases,” in Handbook on the Physics and Chemistry of Rare Earths, Elsevier, p. 207-291 (1995); and G. G. Libowitz and A. J. Maeland, “Hydrides,” in Handbook on the Physics and Chemistry of Rare Earths, Elsevier, p. 299-336 (1979). At low hydrogen-metal fractions of <5 at. %, hydrogen is distributed randomly over the tetrahedrally coordinated sites of the fcc La lattice. Increasing the hydrogen content results in a eutectic phase diagram between this hydrogen-doped La phase and a non-stoichiometric homogeneous hydride LaHₓ for x˜1.9-3.0. The LaH₂ phase has the fluorite fcc structure with hydrogen occupying a large, variable fraction of the tetrahedral sites. Further hydrogenation occurs until LaH₃ is formed, the maximum for the fluorite structure where both the octahedral and tetrahedral interstitial sites are fully occupied by hydrogen. The trend towards higher hydrogen fractions of LaH₃ in FIG. 3 shows that the ball milling process increases the occupation of the more inaccessible octahedral sites.

The higher lanthanum hydride phase is promoted through the application of mechanical ball milling of the lanthanum precursor. This higher hydride phase was realized at room temperature under pressure. Cryomilling delayed the onset of the distorted fcc phase, as shown in FIGS. 4A and 4B, indicating that metastability has been introduced. The stoichiometry of this phase is consistent with a hydrogen content x>3 for LaHₓ based on the volume of the unit cell per formula unit and the distorted fcc structure inferred from the X-ray diffraction data. Hydrogen/metal ratios greater than 3 are considered supervalent, in that the hydrogen must formally exist in one or more combinations of bonding states (interstitial H0, H−, H+, or covalently bound H). For example, intermetallic hydrides with an anisotropic structural distortion, such as described herein, show a mixed ionic/covalent hydrogen bonding character. See V. A. Yartys et al., Z. Kristallogr. Cryst. Mater. 223(10), 674 (2008). The maximum hydrogen/metal ratio, x, observed is ˜4 at the highest pressures studied (60 GPa). However, the data show x>3 at lower pressures with irreversible structural changes upon decompression. Recognizing that hydrides have significant variability in hydrogen content, this phase was assigned as LaH₄. DFT calculations of this LaH₄ phase show an equation-of-state consistent with the data in FIGS. 4A and 4B.

Various alkali tetrahydrides exist with the I4/mmm structure below 60 GPa, the maximum pressure used herein. See M. Peña-Alvarez et al., J. Phys. Chem. Lett. 13(36), 8447 (2022); and A. K. Mishra et al., J. Phys. Chem. C 122(34), 9370 (2018). Lanthanum tetrahydrides were predicted to have a tetragonal I4/mmm structure, confirmed experimentally at pressures of >100 GPa. See T. Bi and E. Zurek, Chem. Eur. J. 27(60), 14858 (2021); H. Liu et al., Proc. Natl. Acad. Sci. 114(27), 6990 (2017); and D. Laniel et al., Nat. Commun. 13(1), 6987 (2022). The XRD data herein was indexed to a rhombohedral structure, i.e., judging from the La positions alone. While hydrogen positions can only be speculated from the optimized DFT prediction with fixed La, the distorted fcc lattice for the structure observed is not close packed and thus can accommodate more than the maximum 3:1 ratio of interstitial to atomic sites expected for an fcc structure. There are no previous literature reports on the behavior of LaH₃ in the pressure range of 30-60 GPa. Cryomilling the La precursor appears to promote the formation of this phase at lower pressures and furthermore this phase must be metastable at pressures <60 GPa, judging from the control experiments and DFT calculations described above. Electronic structure calculations show that this supervalent phase has a finite density-of-states at the Fermi level with a contribution from both La and H orbitals and thus may support hydrogen-promoted superconductivity.

The present invention has been described as a method for preparation of supervalent metal hydrides. It will be understood that the above description is merely illustrative of the applications of the principles of the present invention, the scope of which is to be determined by the claims viewed in light of the specification. Other variants and modifications of the invention will be apparent to those of skill in the art.

1. A method for preparation of a supervalent metal hydride, comprising
providing a metal powder,
cryomilling the metal powder for a milling time to provide a cryomilled metal precursor, and
applying a pressure to the cryomilled metal precursor in the presence of a source of hydrogen sufficient to form a supervalent metal hydride.

2. The method of claim 1, wherein the milling time is greater than 60 minutes.

3. The method of claim 1, wherein the pressure applied is greater than 100 MPa.

4. The method of claim 1, wherein the pressure applied is greater than 10 GPa.

5. The method of claim 1, wherein the pressure applied in less than 100 GPa.

6. The method of claim 1, wherein the applying a pressure step further comprises exposing the cryomilled metal precursor to an elevated temperature in the presence of the source of hydrogen.

7. The method of claim 1, wherein the source of hydrogen comprises a gaseous elemental or molecular form of hydrogen.

8. The method of claim 1, wherein the source of hydrogen comprises a solid-phase hydrogen storage material.

9. The method of claim 8, wherein the solid-phase hydrogen storage material comprises a borohydride, ammonia borane, or hydrazine borane.

10. The method of claim 1, wherein the source of hydrogen comprises a liquid-phase hydrogen storage material.

11. The method of claim 10, wherein the liquid-phase hydrogen storage material comprises a paraffin-based oil, a liquid hydrocarbon, or silicone oil.

12. The method of claim 1, wherein the metal precursor comprises a rare-earth, alkaline earth, or transition metal.

13. The method of claim 12, wherein the rare-earth metal comprises scandium, lanthanum, yttrium, or ytterbium.

14. The method of claim 12, wherein the alkaline earth metal comprises magnesium or calcium.

15. The method of claim 12, wherein the transition metal comprises zirconium or hafnium.

16. The method of claim 1, wherein the pressure is applied by a diamond anvil cell, a piston, or a high-pressure tank.
